(19) United States
(12) Patent Application Publication
(10) Pub. No.: US 2025/0217768 A1
(43) Pub. Date: Jul. 3, 2025

(54) USER INTERFACE FOR A PROJECT MANAGEMENT APPLICATION

(71) Applicant: Atlassian Pty Ltd., Sydney (AU)

(72) Inventors: Lachlan Smith, Sydney (AU); Mark Parnell, Sydney (AU); Rachel Lin, Sydney (AU); Nithin Sudhir, Sydney (AU)

(21) Appl. No.: 18/399,661

(22) Filed: Dec. 28, 2023

(51) Int. Cl. G06Q 10/10; G06F 9/451

(52) U.S. Cl. CPC G06Q 10/103; G06F 9/451

(57) ABSTRACT

Described herein is a computer implemented method. The method includes maintaining a plurality of object updates in a data store, each object update associated with an object and including a latest object information associated with the object. The method further includes displaying a standard user interface that displays a plurality of objects associated with a user, detecting activation of a writing mode control, and replacing the standard user interface with a writing mode interface. The writing mode interface displays a first object update form of a plurality of object update forms. The method further includes while displaying the writing mode user interface, detecting a navigation input and in response to the navigation input, ceasing display of the first object update form and displaying a second object update form of the plurality of the plurality of object update forms in the writing mode user interface.

### TECHNICAL FIELD

Aspects of the present disclosure are directed to human-machine interfaces and more particularly to improved user interfaces for computer applications.

### BACKGROUND

Computer applications may provide functionality for users to collaborate in respect of projects and may provide status updates to users who are subscribed to projects. Organizations may have several projects ongoing simultaneously and users may periodically provide updates about such projects to subscribers. Where users are associated with many projects, it may be challenging for users to write project updates and navigate between updates in respect of different projects without increasing cognitive burden.

### SUMMARY

Example embodiments described herein are directed to a computer implemented method. The method includes maintaining a plurality of object updates in a data store, each object update associated with an object and including a latest object information associated with the object. The method further includes displaying a standard user interface that displays a plurality of objects associated with a user, detecting activation of a writing mode control, and replacing the standard user interface with a writing mode interface. The writing mode interface displays a first object update form of a plurality of object update forms. The method further includes while displaying the writing mode user interface, detecting a navigation input and in response to the navigation input, ceasing display of the first object update form and displaying a second object update form of the plurality of the plurality of object update forms in the writing mode user interface.

Some example embodiments are directed to a system. The system includes a processor and a non-transitory computer readable medium comprising instructions, which when executed by the processor, cause the system to perform the steps of the methods described above.

Other example embodiments are directed to non-transitory computer readable medium which when executed by a processor causes the processor to perform the methods described above.

### BRIEF DESCRIPTION OF THE DRAWINGS

In the drawings:

FIG. 1 is an example object update form.

FIG. 2 is a block diagram of a networked environment in which various features of the present disclosure may be implemented.

FIG. 3 is a block diagram of a computing system with which various embodiments of the present disclosure may be implemented.

FIG. 4 is a flowchart depicting an example method for creating object updates according to embodiments of the present disclosure.

FIG. 5 is an example first update user interface (standard user interface) according to embodiments of the present disclosure.

FIG. 6 is an example second object update user interface (writing mode user interface) according to embodiments of the present disclosure.

FIG. 7 is a flowchart illustrating an example method for writing two or more project updates according to embodiments of the present disclosure.

FIG. 8 is the example writing mode user interface of FIG. 6 in a second state according to embodiments of the present disclosure.

FIG. 9 is the example writing mode user interface of FIG. 6 in a third state according to embodiments of the present disclosure.

FIG. 10 is the example writing mode user interface of FIG. 6 in a fourth state according to embodiments of the present disclosure.

While the description is amenable to various modifications and alternative forms, specific embodiments are shown by way of example in the drawings and are described in detail. It should be understood, however, that the drawings and detailed description are not intended to limit the disclosure to the particular form disclosed. The intention is to cover all modifications, equivalents, and alternatives falling within the scope of the present disclosure as defined by the appended claims.

### DETAILED DESCRIPTION

In the following description numerous specific details are set forth in order to provide a thorough understanding of the present disclosure. It will be apparent, however, that the present disclosure may be practiced without these specific details. In some instances, well-known structures and devices are shown in block diagram form in order to avoid unnecessary obscuring.

The methods, user interfaces, and systems described herein can be employed with any computer application that requires updating or reviewing a plurality of UI objects or UI cards in a single user interface. For example, the methods, UIs, and systems described herein can be utilized for displaying/writing project updates, goal updates, social media updates, etc., without departing from the scope of the present application.

An object or UI card according to the present disclosure is a UI element associated with a particular topic that includes information about the topic. For example, in the case of a social media application, a UI card may be a post or tweet that includes the actual post or tweet text, information about the author of the post, and other information such as date posted, number of interactions with the post, etc. In the case of a project management application, a UI card may be a task card that includes details about the task including, e.g., task creation date, task completion date, assignee, status, etc. Similarly, in the case of a project communication tool, a UI card may be a project update object that includes information about the project update including, e.g., project name, project owner, status, update description, etc.

Aspects of the present disclosure are described with respect to a particular example computer application-a project communication tool that provides status updates of projects and user interfaces therefor. For ease of reference, the acronyms PCT or PC will at times be used herein in place of “project communication tool” or “project communication,” respectively. It will be appreciated that this type of computer application is merely used as an example and as described above, aspects of the present disclosure can be used with any other computer applications, such as a social media application, a project management application, etc., without departing from the scope of the present disclosure.

As discussed above, organizations may have several projects ongoing simultaneously and may implement computer applications, for example a PCT application, for users to collaborate in respect of the projects. Generally speaking, the PCT provides status updates of projects. Specifically, the PCT allows users to conveniently create and subscribe to (e.g., follow) projects. The tool is also configured to automatically prompt project owners or other project contributors for periodic project updates and deliver digests of project updates (subscriber updates) to subscribers. The PCT may also be used to create and update goals which may relate to one or more projects.

Project and/or goal updates (and digests thereof) may be provided to subscribers by displaying UI cards or objects for the updates in a user interface (UI) of the PCT and allowing the subscriber to view the updates. Some PCTs may be configured to automatically and periodically request project/goal owners or contributors to provide updates for all active projects maintained by the tool according to a defined update cadence (e.g., a particular time/day of every week; a particular time/day of every fortnight; a particular time/day of every month, etc.). Other tools may allow project owners to define specific/bespoke project update request cadences for individual projects (or project groups) independently of other projects. In any event, the tool generates project update requests and communicates these to the corresponding project owners or project contributors at the defined cadence. The project update request (and data included therein) may take various forms.

For example, a project update request may take the form of an electronic communication (e.g. an email, an instant message, an SMS, or an alternative electronic communication) and include a link or control that, when activated by the project owner/contributor, displays a project update UI (e.g. project update UI 100 described below). The project owner/contributor may then input project update data in the project update UI, which is subsequently communicated to and received by the tool.

Once the required update data has been received, the tool creates a project update for the respective project based on the project update data received for that project and stores this project update against the project identifier for the project. If the tool does not receive a project update within a predefined time period of communicating an update request, the tool may generate and communicate a reminder to the project owner/contributor for that project.

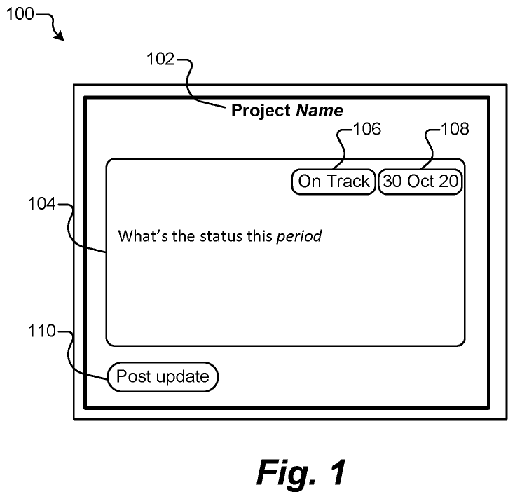

FIG. 1 shows an example project update UI 100 for project owners/contributors to submit project updates. The project update UI 100 may be displayed when the project owner/contributor is to provide a project update relating to their project. For example, the project update UI 100 may be displayed in response to a project owner selecting a ‘provide update’ control or link provided with a project update prompt. The project update UI 100 includes a project name section 102, a project update data entry control 104, a project status control 106, a timestamp indicator 108, and a post update control 110.

The project name section 102 displays the project field data relating to the project name of the project the project owner is submitting a project update for. The project update data entry control 104 allows the project owner to input an update description (e.g. text) explaining the project update. The update description may be limited to a predefined maximum number of words or characters (e.g. 280 characters) to force the project owner to provide a succinct project update for their project. If the project owner wishes to provide more words/characters beyond the word/character limit or more information relating to the project update, the project update UI 100 may include a notes control. If the project owner selects the notes control, a notes data entry control may be displayed within the project update UI 110 that allows the project owner to provide more information relating to the project (e.g. more characters/words beyond the limit and/or images).

The project status control 106 indicates the current project status of the project in question. The project status control 106 is prepopulated with the current status of the project. For example, the tool may determine the project identifier to which the project update interface 100 relates, access the most recent project update record for the project in question, extract the project status from that project status update record, and display that project status in the project status control 106. The tool may determine the most recent project update record for a project based on the project identifier and timestamp of each project update record in a project updates table.

The project owner can update the project status of the project by selecting the project status control 106. Selection of the project status control 106 displays a list of predefined project statuses in the project update UI 110 from which the project owner can choose from (e.g. “Pending”, “On track”, “At risk”, “Off track”, “Paused”, “Cancelled”, “Completed”, or the like).

The timestamp indicator 108 indicates the time and/or date the project owner is submitting the project update. This may be prepopulated based on the current time and date at which the project owner is submitting the project update.

The post update control 110 allows a project owner to post (i.e. submit) the project data they have entered in the project update UI 100. Selection of the post update control 110 causes creation of a project update for the project in question.

This UI 100 may be suitable when a user has to update a single object—e.g., a single project or goal. However, often a single user may be responsible for a number of projects. If all the projects have to be updated at the same cadence and time (e.g., at 9 am every Friday), the user has to visit each project's UI and select a ‘provide update’ control or link from that UI to display UI 100. Once the update is written for one project, the UI 100 closes and the user has to visit the next project UI and initiate the same process again. As will be appreciated, this is time consuming and significantly increases the cognitive burden on the user—the user has to not only remember each project and/or goal they have to update, but also cycle through that process for each project/goal separately. Further, this process may require cycling between various different UIs and many key strokes, which can be difficult in small form factor devices such as mobile phones.

Accordingly, it may be desirable to have improved user interfaces for computer applications which enable more efficient and effective mechanisms to generate multiple UI objects or cards.

In the following, an overview of an example environment illustrating different systems involved in certain embodiments will be described, followed by a description of a computer system which can be configured in various ways to perform the embodiments/various features thereof as described herein. Following this, exemplary user interfaces of a project communication software tool will be described.

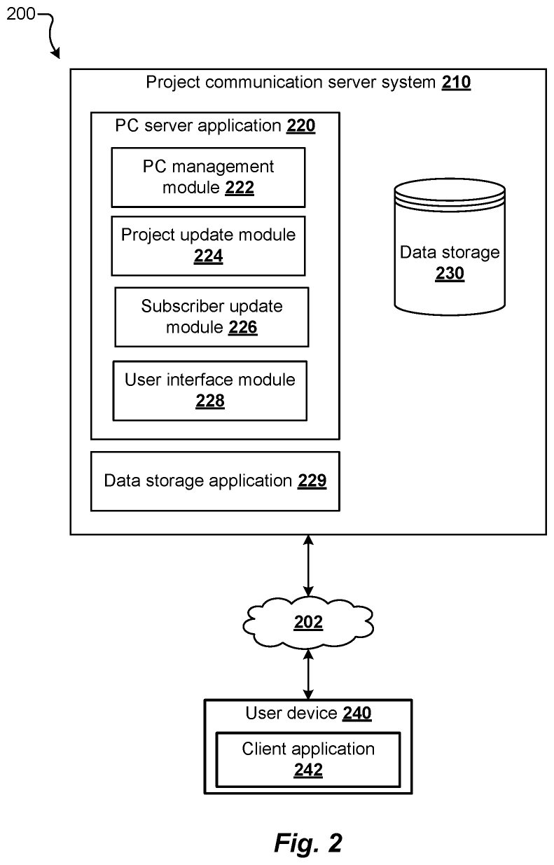

FIG. 2 illustrates an example environment 200 in which embodiments and features of the present disclosure are implemented. Example environment 200 includes a communications network 202 which interconnects a project communication server system 210, and a user device 240.

The project communication server system 210 includes a PC server application 220 (server application 220 for short) and a PC server system data store 230 (data store 230 for short). The data store 230 is used for storing data related to functions performed by the server application 220, for example, project data of one or more projects managed by the PC server application 220.

The server application 220 and its respective modules configure the PC server system 210 to provide server side functionality for client applications (e.g., client application 242). Generally speaking, this involves receiving and responding to requests from client applications (e.g. client application 242 discussed below). The server application 220 may be a web server (for interacting with web browser clients) or an application server (for interacting with dedicated application clients). While PC server system 210 has been illustrated with a single server application 220, it may provide multiple server applications (e.g. one or more web servers and/or one or more application servers).

In this example, the server application 220 includes a PC management module 222, a project update module 224, a subscriber update module 226, and a UI module 228.

Generally speaking, the PC management module 222 is configured to collect project data when a project is created and store the collected project data in the data store 230. The PC management module 222 is also configured to collect subscriber data (e.g., user identifiers who have subscribed to a project) and store the subscriber data in the data store 230. As an example, the PC management module 222 may be configured to write the project data to a project details record in a project details table stored on the data store 230 and write the subscriber data to a respective subscriber record of a subscriber table stored on the data store 230. For ease of reference, the PC management module 222 may, at times, be referred to herein as a PCM module.

The project update module 224 is configured to periodically prompt a project owner/contributor (e.g. through the client application 242 on user device 240) to provide a project update relating to their project. The project update module 224 is also configured to receive project updates from a project owner/contributor (e.g. using the client application 242 on user device 240) and store the project updates in the data store 230. As an example, the project update module 224 may be configured to write each received project update to a project update record in a project updates table stored on the data store 230.

The subscriber update module 226 is configured to periodically provide project updates to subscribers. For a given subscriber (i.e. user), the subscriber update module 226 is configured to periodically retrieve project updates (e.g. from the data store 230) relating to the projects the subscriber has subscribed to and generate a subscriber update based on the retrieved project updates. After the subscriber update module 226 has generated the subscriber update, the subscriber update module 226 is configure to communicate the subscriber update to the subscriber. The subscriber update module 226 may communicate the subscriber update to the subscriber through client application 242 on user device 240, by email to the subscriber's nominated email address(es), and/or other communication means. As an example, the subscriber's user identifier stored in a subscriber table may be used to identify the subscriber's details in a user table to determine the subscriber's nominated email address(es).

The UI module 228 is configured to generate and display user interfaces to client applications, for example, on client application 242 of user device 240. The user interfaces are configured to enable a user to input project updates relating to projects they are the owner of and/or to display project updates relating to projects they are subscribed to. The UI module 228 and the interfaces it provides are also configured to enable various control elements, for example buttons and/or affordances which may be activated selecting the element with a touch gesture and/or by clicking with a cursor. UI control elements may also include inputs received from input devices, such as physical buttons of a user device and/or a keyboard. As will be outlined below, the UI module 228 may provide various control elements and functionalities responsive to detecting user input and/or activation of the control elements.

The data storage application 229 is configured to receive and process requests to persistently store and retrieve, to and from data store 230, data relevant to the operations performed/services provided by the server application 220. Such requests may be received from the server application 220, other server environment applications, and/or (in some instances) directly from client applications such as 242. The data storage application 229 may, for example, be a relational database management application or an alternative application for storing and retrieving data from data store 230. Data relevant to the operations performed/services provided by the server system 210 may include, for example, user account data, project data, project update data, goal data, subscriber data, and other data as described herein.

In the present example, the project communication management module 222, the project update module 224, the subscriber update module 226, and the UI module 228 have been described as modules of the server application 220—for example add-ons, plug-ins, or other software components that integrate with and expand the functionality of the server application 220. The functionality provided by one or more of these modules could, however, be performed by separate/stand-alone applications. As a further alternative, the functionality provided by one or more of these modules could be native functionality of the server application 220.

In certain embodiments, the PC server system 210 is a scalable system. Depending on demand from clients (and/or other performance requirements), compute nodes can be provisioned/de-provisioned on demand. As an example, if there is high client demand additional server applications 220 may be provisioned to cater for that demand. In this case, each functional component of the PC server system 210 may involve one or several applications running on the same or separate computer systems, each application including one or more application programs, libraries, APIs, or other software that implements the functionality described herein.

The server application 220 executes to provide a client application endpoint that is accessible over communications network 202. To do so, the server application 220 may include one or more application programs, libraries, APIs or other software elements that implement the features and functions that are described herein. For example, where server application 220 serves web browser client applications the server application 220 will be a web server which receives and responds to, for example, HTTP application protocol requests. Where server application 220 serves native client applications, server application 220 will be an application server configured to receive, process, and respond to API calls from those client applications

The server system 210 may include both web server and application server applications allowing it to interact with both web and native client applications.

Server application 220 (and/or other applications running in the server system 210) can be implemented as a monolithic application. Alternatively, server application 220 can be implemented as a collection of independent and autonomous application services (e.g., microservices). In this case, the constituent application services of server application 220 communicate amongst themselves, with other front end server applications 220, and/or with client application 242, via defined interfaces such as web APIs.

In addition to the specific functionality described herein, the server application 220 (alone or in conjunction with other applications) may provide additional functions that are typically provided by server systems—for example user account creation and management, user authentication, and/or other server side functions.

Data store 230 may be any appropriate data storage device (or set of devices), for example one or more non transient computer readable storage devices such as hard disks, solid state drives, tape drives, or alternative computer readable storage devices. Furthermore, while a single instance of data store 230 is described, server system 210 may include multiple instances of data storage.

The user device 240 includes a client application 242, which, when executed by the user device 240 (e.g. by a processing unit such as 302 described below), configures the user device 240 to provide project communication functionality to allow users to do one or more of: create projects, update projects, subscribe to projects, and/or receive project updates. This involves communicating with the PC server system 210 (and, in particular, the server application 220).

The client application 242 may be the same for project subscribers and project owners/contributors. However, it is envisaged that the user device 240 and client application 242 may be different and operate differently for project owners/contributors and subscribers. For example, the client application 242 for project owners may be different to (and/or may have more functionality when compared to) the client application for subscribers. In some cases, subscribers may not even need a client application 242 if subscriber updates are, for example, delivered by email or other communication means. Further, it will be appreciated that in some cases, a project owner for one project may be a project subscriber for another project and vice versa.

The client application 242 may be implemented in various ways. For example, the client application 242 may be web browser applications (such as Chrome, Safari, Internet Explorer, Firefox, or an alternative web browser), which access the applications hosted by the PC server system 210 via appropriate uniform resource locators (URL) and communicate with the PC server system 210 via general world-wide-web protocols. In this case, the web browser application is configured to request, render, and display UIs that conform to a mark-up language, and may be capable of internally executing browser-executable code, or other forms of code. Alternatively, the client applications 242 may be specific applications programmed to communicate with the PC server system 210 using defined application programming interface (API) calls.

In the present example, while a single user device 240 and a single client application 242 has been depicted, environment 200 will typically include multiple user devices 240 and multiple client applications 242, each configured to interact with the PC server system 210. User device 240 may be any form of computing device. Typically, user device 240 is a personal computing device—e.g. a desktop computer, laptop computer, tablet computer, smart phone, or other computing device.

Communications between the various systems in environment 200 are via the communications network 202. Communications network 202 may be a local area network, public network (e.g. the Internet), or a combination of both.

While environment 200 has been provided as an example, alternative system environments/architectures are possible.

The features and techniques described herein are implemented using one or more computer processing systems. For example, in networked environment 200 described above, user device 240 may be computer processing systems (for example, a personal computer, tablet/phone device, or other appropriate computer processing system) which is configured (or configurable) by hardware and/or software to offer client-side functionality. Similarly, the various functions performed by the PC server system 210 are performed by one or more computer processing systems (e.g. server computers or other computer processing systems).

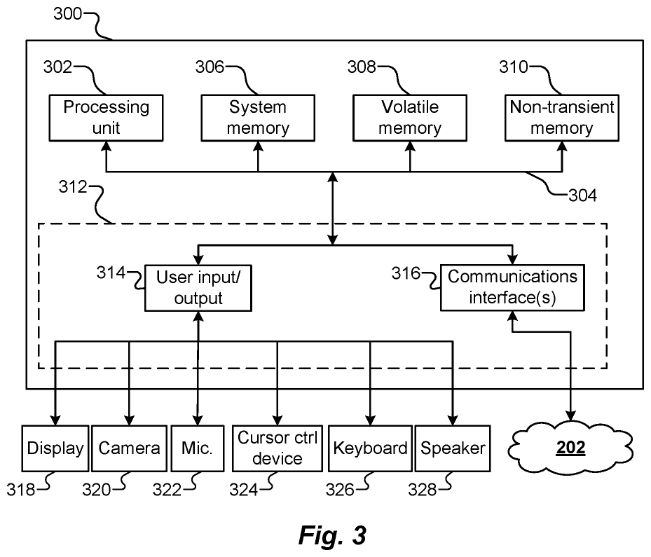

FIG. 3 is a block diagram of a computer processing system 300 configurable to perform various functions described herein. For example, systems 210 and/or 240 of FIG. 2 may be (or include) a computer processing system such as that shown in FIG. 3 (although alternative architectures are possible).

System 300 is a general purpose computer processing system. It will be appreciated that FIG. 3 does not illustrate all functional or physical components of a computer processing system. For example, no power supply or power supply interface has been depicted, however system 300 either carries a power supply or is configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 300 includes at least one processing unit 302. The processing unit 302 may be a single computer processing device (e.g. a central processing unit, graphics processing unit, or other computational device), or may include a plurality of computer processing devices. In some instances, where a computer processing system 300 is described as performing an operation or function all processing required to perform that operation or function will be performed by processing unit 302. In other instances, processing required to perform that operation or function may also be performed by remote processing devices accessible to and useable by (either in a shared or dedicated manner) system 300.

Through a communications bus 304, the processing unit 302 is in data communication with one or more machine readable storage (memory) devices which store instructions and/or data for controlling operation of the processing system 300. In this example system 300 includes a system memory 306 (e.g. a BIOS), volatile memory 308 (e.g. random access memory such as one or more DRAM modules), and non-volatile memory 310 (e.g. one or more hard disk or solid state drives).

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g. networked) connection.

Wired connection with other devices/networks may be by any appropriate standard or proprietary hardware and connectivity protocols. For example, system 300 may be configured for wired connection with other devices/communications networks by one or more of: Universal Serial Bus (USB); eSATA; Thunderbolt; Ethernet; HDMI. Other wired connections are possible.

Wireless connection with other devices/networks may similarly be by any appropriate standard or proprietary hardware and communications protocols. For example, system 300 may be configured for wireless connection with other devices/communications networks using one or more of: infrared; BlueTooth; WiFi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Depending on the particular system in question, devices to which system 300 connects include one or more input devices to allow data to be input into/received by system 300 and one or more output devices to allow data to be output by system 300. Example devices are described below, however it will be appreciated that not all computer processing systems will include all mentioned devices, and that additional and alternative devices to those mentioned may well be used.

For example, system 300 may include or connect to one or more input and output devices 314 by which information/data is input into (received by) system 300. Such input devices may, for example, include a keyboard, a pointing device (such as a mouse or trackpad), a touch screen, and/or other input devices. System 300 may also include or connect to one or more input and output devices controlled by system 300 to output information. Such output devices may, for example, include one or more display devices (e.g. a LCD, LED, touch screen, or other display devices) and/or other output devices. System 300 may also include or connect to devices which act as both input and output devices 314, for example touch screen displays (which can receive touch signals/input and display/output data) and memory devices (from which data can be read and to which data can be written).

By way of example, where system 300 is an end user device (such as user device 240), it may include one or more of: a display 318 (which may be a touch screen display), a camera device 320, a microphone device 322 (which may be integrated with the camera device), a cursor control device 324 (e.g. a mouse, trackpad, or other cursor control device), a keyboard 326, one or more other input/output devices, and a speaker device 328.

System 300 also includes one or more communications interfaces 316 for communication with a network, such as network 202 of FIG. 2 (and/or a local network within the server system 210). Via the communications interface(s) 316, system 300 can communicate data to and receive data from networked systems and/or devices.

System 300 may be any suitable computer processing system, for example, a server computer system, a desktop computer, a laptop computer, a netbook computer, a tablet computing device, a mobile/smart phone, a personal digital assistant, or an alternative computer processing system.

System 300 stores or has access to computer applications (which may also be referred to as computer software or computer programs). Such applications include computer readable instructions and data which, when executed by processing unit 302, configure system 300 to receive, process, and output data. Instructions and data can be stored on non-transient machine readable medium such as 310 accessible to system 300. Instructions and data may be transmitted to/received by system 300 via a data signal in a transmission channel enabled (for example) by a wired or wireless network connection over an interface such as communications interface 316.

Typically, one application accessible to system 300 will be an operating system application. In addition, system 300 will store or have access to applications which, when executed by the processing unit 302, configure system 300 to perform various computer-implemented processing operations described herein. For example, and referring to the networked environment of FIG. 2 above, server system 210 includes one or more systems 300, which run a server application 220 to perform various operations described herein. Similarly, user device 240 runs a client application 242. In some cases part or all of a given computer-implemented method will be performed by system 210 itself, while in other cases processing may be performed by other devices (e.g. user device 240) in data communication with system 210.

Application 242 is configured to display an input UI, e.g. on display 318. Server application 220 (e.g. using the UI module 228) may communicate with client application 242 to display the input UI. The input UI provides a mechanism for a user to engage with a project communication tool to create and subscribe to projects, to update projects, and to receive digests of project updates. In the present disclosure, the input UI provides a mechanism for users to interface with the PCT. Various input UIs are possible. One example is graphical user interface (GUI) and particular examples of GUIs will be outlined in the following description, although alternative UIs are also possible.

Data in respect of users, updates, and projects may be stored in various formats in the data store 230. This section describes data structures which may be employed in the present disclosure to generate and store projects, project updates, and subscriber updates. The data structures and fields described are provided by way of example only. Depending on the implementation, alternative design formats, which make use of the same, additional, fewer, and/or alternative fields may be used, and the processing described herein can be adapted for alternative formats. Further, the fields described in respect of a given data structure may be stored in one or more alternative data structures (e.g. across multiple linked data structures).

Generally speaking, a project is a set of collected project data relating to a project as defined by project fields. By way of example, project fields may include fields such as a unique project identifier field for storing an identifier used to uniquely identify a project, a project owner/contributor field for storing a user identifier of an individual (or a team) who is assigned the role of project owner/contributor, a project name field for storing a name for the project, a project status field for storing a value indicating a current status of the project. For example, a project status may be selected from a set of system or user defined status values. Example status values may include, but are not limited to, statuses such as “on track”, “at risk”, “ahead of schedule”, “behind schedule”, “completed on schedule”, “completed behind schedule”, or the like. It will be appreciated that other status values may be used. It is also envisaged that a project creator and/or owner may be able to add custom status values.

In addition, the project fields may include a project target date field for storing a value indicating a target date of completion of the project. The project target data may indicate a specific date (e.g. a specific day), a period of time (e.g. a specific month or a specific quarter), or that selection of a completion date or period has been deferred.

It will be appreciated that the above list is not exhaustive and that a project may include additional and/or alternative project fields. Further, while some project fields may be made mandatory/required not all will be.

Project data—i.e. data defining project fields such as those above—may be stored in any appropriate data structure (or set of related data structures). By way of example, the project data may be stored in a set of related database tables as set out below.

In this example, a project details table stores project details records defining various data in respect of a project. For example, each project details record may store the following data:

| | Project | | | |
|---|---|---|---|---|
| Project | owner/contributor | Project | Project | Project |
| ID | ID | name | status | target date |
| [symbol] | [symbol] | [symbol] | [symbol] | [symbol] |

[symbol]

indicates data missing or illegible when filed

The data store 230 may further store a project subscriber table associating subscribers (i.e. individuals and/or teams) with projects. In this example, each subscriber table record defines a subscriber identifier (e.g. a user identifier) and a project identifier. For example:

| Project ID | Subscriber ID |
|---|---|
| [symbol] | [symbol] |

[symbol]

indicates data missing or illegible when filed

The data store 230 may further store a project update table storing project updates submitted by the project owners/contributors. The project update table defines project update records, each of which includes: a project update identifier; a project identifier; an update timestamp recording the time and/or date the project update was submitted; an update description providing details of the project update; a project status defining the project status of the project at the time of the update; a project target date indicating the target date of completion at the time of the update; and a remarks field for any comments and/or reactions submitted by subscribers relating to the project update. Below is an example of a project update table.

| | | | | | | |
|---|---|---|---|---|---|---|
| Project | Project | Project | Update | Project | Project | Remarks |
| update | ID | update | descrip- | status | target | |
| ID | | timestamp | tion | | date | |

Project updates may be uniquely identified based on their project update identifier. Alternatively, project updates may be identified based on a combination of the respective project identifier and project update timestamp.

The data store 230 may further store subscriber updates as a collection of project updates in a subscriber update table. The subscriber update table defines subscriber update records, each of which includes: an associated subscriber identifier; a subscriber update identifier; a subscriber update period recording the period of time the subscriber update was generated for, project identifiers for projects the subscriber is subscribed to; and project update identifiers for project updates of projects the subscriber is subscribed to. Below is an example of a project update table.

| Subscriber | Subscriber | Subscriber | Project | Project |
|---|---|---|---|---|
| ID | update ID | update period | IDs | update IDs |
| [symbol] | [symbol] | [symbol] | [symbol] | [symbol] |

[symbol]

indicates data missing or illegible when filed

Additional and/or alternative data structures (with additional and/or alternative fields) may be used to store project data. Furthermore, while in the example above a relational database model has been used alternative database models could be used (e.g. a key-value pair data store or alternative database model).

In overview, the process of creating and managing projects in the PCT generally includes users (e.g., project owners) creating projects, users subscribing to projects, project owners/contributors providing updates on projects they own (or work on), and updating subscribers in respect of the projects they subscribe to, which are briefly described below.

As used herein, a “project update” refers to information related to (or contained in) an update provided by a project owner/contributor in respect of a project they own. For example, a user providing data to the PCT system in respect of a project they own and the system populating a project update record based on the user provided data. As used herein, a “subscriber update” refers to communicating one or more project updates in respect of project(s) to a subscriber who is subscribed to the project(s). For example, the PCT system communicating information related to (or contained in) a project update record, in respect of a project, to a user subscribed to the relevant project. In a subscriber update process, a collection of project updates may be communicated to a subscriber as a subscriber update. In this way, a subscriber update is a project update digest in respect of a given subscriber for a given update period. Whilst the description below is primarily in respect of projects and project updates, the PC application may also create and update goals, and display goal updates, as part of a subscriber update, in a corresponding manner to that of projects and project updates.

Subscribing to projects includes subscribing users to projects based on requests from users (e.g. using client application 242 on user device 240) to be subscribed to a project so that they receive project updates with respect to that project. As an example, the PCM module 222 may detect a user (e.g. using client application 242 on user device 240) activating a subscribe/follow control for the project that is presented by a UI on a display (e.g. display 318 of user device 240). In response to detecting the activation of the subscribe/follow control, the PCM module 222 subscribes the user to the project by associating the user with the project in the data store 230. For example, the PCM module 222 may create a project subscription record (including the user ID and project ID) and write this to a project subscription table. The user may have to login to the client application 242 before they subscribe to projects and the PCM module 222 may be able to determine the user identifier of the user based on their login details. Alternatively, the user may provide their user identifier after activating the subscribe control. It is also envisioned that multiple users may be subscribed to one or more projects and that users may also unsubscribe or unfollow projects, for example, by activating a toggle follow/following control of a respective project.

Updating projects may include the project update module 224 periodically prompting project owners/contributors (e.g. through the client application 242) to provide a project update relating to their project, receiving such an update, and storing the project update in data store 230. For example, the project update module 224 may be configured to automatically and periodically request updates for all active projects maintained by system 210 according to a defined project update request cadence. For example, the project update request cadence may be defined so that project update processes are triggered for projects at: a particular time/day (the update time) of every week (the update period) (e.g. every Friday at 9 am); a particular time/day of every fortnight (e.g. every second Friday at 9 am); a particular time/day of every month (e.g. 9 am on the first Friday of every month), or at alternatively defined intervals. Project update request cadence may be configured as common, for all projects and project owners/contributors, or specific cadences may be defined for specific projects and/or project owners/contributors.

For each project update process, the project update module 224 determines the user identifier of the project owners/contributors of the project in question. As an example, the project update module 218 may determine the user identifier of the project owners/contributors by accessing a project details table stored in the data store 230. The project update module 218 generates a project update request. The project update request is a request to the project owners/contributors for a project update. The project update request (and data included therein) may take various forms. For example, the project update request may be provided in the form of an electronic communication (e.g. an email, an instant message, an SMS, or an alternative electronic communication) and include a link or control that, when activated by the project owners/contributors, causes the client application 242 to generate and display a project update UI. The project owners/contributors may then input project update data in the project update UI, which is subsequently communicated to and received by the project update module 224. Additionally or alternatively, in some embodiments, project updates may be provided by project owners/contributors before receiving project update requests.

Once the required update data has been received, the project update module 224 creates a project update for the respective project based on the project update data received for that project and stores this project update against the project identifier for the project in the data store 230. For example, creating a project update may involve the project update module 224 creating a project update record in a project updates table stored on the data store 230 and populating the project update fields as discussed above. The project update record defines the unique project identifier for the project to which the project update relates and one or more project update fields (e.g. the time the project update was created, the update description, and the project status).

Broadly speaking, subscriber update processes include generating a subscriber update for a subscriber (the subscriber update including project updates for projects the subscriber has subscribed to) and communicating the subscriber update to the subscriber. The subscriber update module 226 is configured to automatically and periodically generate updates for all users who subscribe to one or more projects according to a defined subscriber update cadence. For example, the subscriber update cadence may be defined so that subscriber update processes are triggered for subscribers at: a particular time/day (the update time) of every week (the update period) (e.g. every Friday at 9 am); a particular time/day of every fortnight (e.g. every second Friday at 9 am); a particular time/day of every month (e.g. 9 am on the first Friday of every month), or at alternatively defined intervals. Subscriber update cadence may be configured as common, for all projects and subscribers, or specific cadences may be defined for specific projects and/or subscribers. Generally, subscriber update cadence is configured as complimentary to project update cadence such that subscribers are provided updates of projects at the same or similar rate to which project owners/contributors update projects.

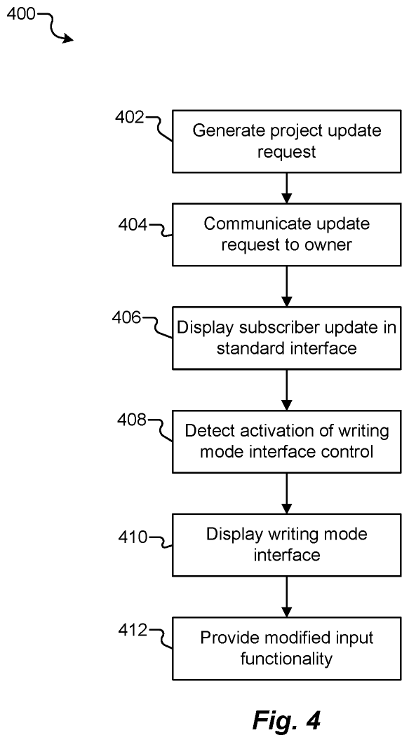

Turning to FIG. 4, a project update process 400 for receiving project updates from a project owner/contributor is described. The operations of method 400 are described as being performed by the PC server application 220 running on the PC server system 210 and the PC client application 242 running on the user device 240. In alternative embodiments, the processing may be performed by one or more alternative systems (operating in conjunction with PC server system 210 and user device 240 or independently) and/or alternative applications running on those systems. Additionally, the method 400 will be described with reference to providing a single project owner an update request, although the method may be scaled to provide multiple project owners/contributors respective update requests.

The process 400 may commence once a project update process is triggered. A project update process may be triggered in various ways. For example, in the present embodiment, the project update module 224 is configured to automatically and periodically request updates for all active projects maintained by system 210 according to a defined update request cadence. The defined update request cadence may define an update request period (i.e. when the project update process repeats) and an update request time (i.e. when the project update process is triggered within a given period). For example, the update request cadence may be defined so that project update processes are triggered for all projects at: a particular time/day (the update time) of every week (the update period) (e.g. every Friday at 9 am); a particular time/day of every fortnight (e.g. every second Friday at 9 am); a particular time/day of every month (e.g. 9 am on the first Friday of every month), or at alternatively defined intervals.

In alternative embodiments, system 210 may allow project owners/contributors to define specific/bespoke project update request cadences for individual projects (or project groups) independently of other projects. A defined specific project update request cadence may define a specific project update request period (i.e. when the specific project update process repeats) and a specific project update request time (i.e. when the specific project update process is triggered within a given period). For example, the specific project update request cadence may be defined so that a project update process is triggered for the specific project at: a particular time/day (the update time) of every week (the update period) (e.g. every Friday at 9 am); a particular time/day of every fortnight (e.g. every second Friday at 9 am); a particular time/day of every month (e.g. 9 am on the first Friday of every month), or at alternatively defined intervals.

Once a project update process is triggered, the project update module 224 determines the user identifiers of the project owners/contributors of the projects in question. As an example, the project update module 224 may determine the user identifiers of the project owners/contributors by accessing the project details table stored in the data store 230.

At step 402, the project update module 224 generates a project update request. The project update request is a request to the project owner/contributor for a project update. The project update request (and data included therein) may take various forms.

For example, in some examples, the project update request may take the form of an electronic communication (e.g. an email, an instant message, an SMS, or an alternative electronic communication) and include a link or control that, when activated by the project owner/contributor, causes the client application 242 to generate and display a project update UI (e.g. project update UI 100 described above). In another example, in addition to or instead of the electronic communication described above, the project update module 224 may cause the client application 242 to display a project update control in one or more PCT user interfaces displayed by the client application 242.

At step 404, the project update module 224 communicates the project update request generated at step 402. Communication of the project update request depends on the type of project update request—e.g. by email, instant message, SMS, as an interactive control in a displayed UI, or other communication means. At step 406, subscriber updates are displayed in standard interface.

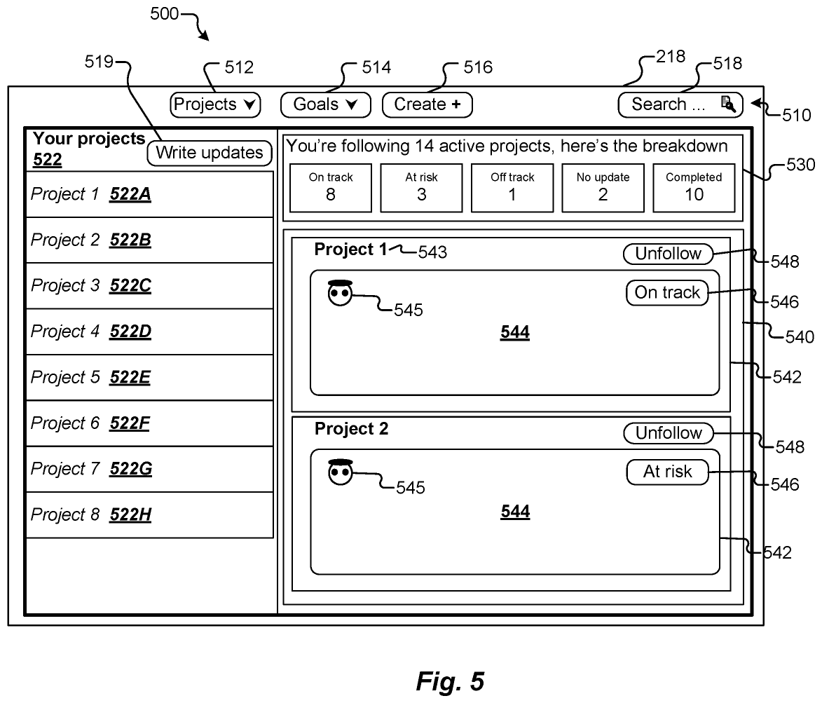

FIG. 5 illustrates an example UI 500 that may include the interactive control for updating projects. The UI 500 may be (or correspond to) a default or homepage interface for displaying project details to users of the PC client application 242, for example, when the user first navigates to or opens the PC client application. The UI 500 may be displayed in response to the subscriber activating the update request control in a communication. Alternatively or additionally, the UI 500 may be provided as a default home page for example, for displaying the (current) most recent project details when a user initially navigates to the PC client application 242 on their user device 240. The UI module 228 is configured to cause the PC client application 242 to display the UI 500, for example, on display 318 of the user device 240.

The interface 500 includes a header section 510 containing control elements including a projects control element 512, a goal control element 514, a create control element 516, and a search control element 518. Selection of the various control elements results in the operation of corresponding actions. For example, selection of the projects control element 512 causes display of a projects section 520. The projects section 520 displays a list of projects 522 owned by a user viewing the interface 500. In this example, the user owns eight projects-projects 522A-522H.

Selection of the goals control element 514 causes display of a similar goals section for displaying a list of goals subscribed to (i.e. followed) and/or owned by the user viewing the interface. Selection of the create control element 516 triggers operation of a method for a user to create a project or goal. Selection of the search control element 518 triggers operation of a search process to search for users, projects, and/or goals within the PC application.

The interface 500 further includes a summary section 530 displaying a summary of the active projects the user viewing the interface has subscribed to follow, and a project updates section 540. The project updates section 540 displays project update objects 542 for each project the user has subscribed to or is a part of. The project updates section 540 is a scrollable interface for allowing a subscriber to view each project update object 542 by scrolling through a list of project update objects 542. In one example, the project updates section 540 may be configured as an infinite scroll interface, allowing a user to scroll through (and down to) respective project update objects 542.

The project update objects 542 may include, e.g., a project name 543, a project update description 544, an avatar 545, a status indicator 546, and an unfollow control 548. The project update description 544 may include text or other content that has been entered with respect to the respective project update that was received by the system. Similarly, the status indicator 546 may reflect a status that was entered by the user or is being tracked by the system for the respective project update object 542. The unfollow control 548 may be a selectable affordance that, when selected, causes the respective subscriber to unsubscribe from the updates from the respective project, issue or user associated with the project update object 542.

In addition, according to aspects of the present disclosure, the projects section 522 further includes an update control element 519. Selection of the update control element 519 causes display of a writing mode user interface (e.g. interface 600 described further below) on the display 318.

Returning to method 400, at step 408, the UI module 228 detects that a user wishes to write one or more project updates. The UI module may detect this, e.g., because a user activates the update control 519 or activates any other shortcut key (e.g., the W key) that is associated with the writing mode user interface. The activation of the update control or shortcut key may be detected based on a user input provided at their user device 240.

In response to detecting that the user wishes to write one or more project updates, the client application 242 generates a request for a writing mode user interface and communicates the request back to the PC server system 210 (via network 202). The request may include an identifier associated with the user of the user device 240. The PC server system 210 receives the request and retrieves project update data for the request.

In some embodiments, the project update module 224 inspects the data store 230 and in particular the project details table using the user identifier received in the request to identify one or more projects associated with the user identifier. For example, it identifies each of the projects that include the user identifier as a project owner/contributor identifier.

The project update module 224 further performs a lookup with the identifiers of the identified projects in the project updates table to determine when the identified projects were last updated. It also retrieves the latest project updates associated with the identified projects. The project update module 224 then communicates the list of projects for which the current user is the owner/contributor and data about the previous updates for those projects to the client application 242.

At step 410, the client application 242 utilizes this information to generate and render a writing mode UI. The writing mode user interface provides a single, focussed interface to write project updates without requiring the need to jump between window tabs. For example, it is specifically configured to allow users to write updates for multiple projects from a single UI while providing enhanced input functionalities.

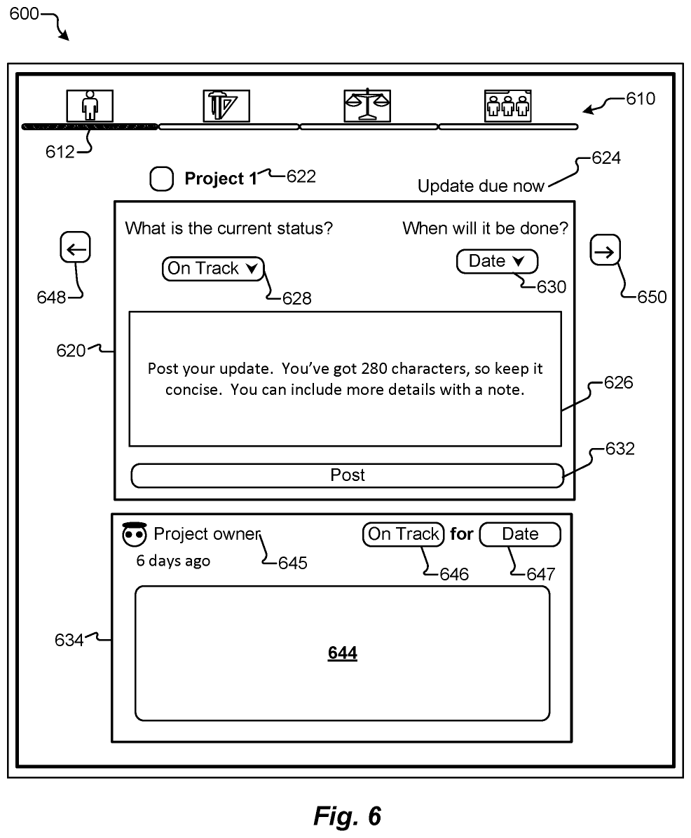

FIG. 6 illustrates an example writing mode user interface 600. The interface 600 includes a project update queue 610 (based on the list of projects received from the PC server application 220). In general, the project updates that the user currently viewing the interface has to write will be queued for display in corresponding project update objects 620 in a predetermined order (e.g., alphabetically, based on urgency, based on project status, etc.) When the order is based on a time property, the order can be determined based on the project update timestamp of the previous project update record for the corresponding projects).

In some examples, the project update queue 610 includes an interactive element 612 for each project the user is the owner/contributor for (irrespective of whether a project update has already been written for the corresponding project in that particular period or not). In such examples, the queue may arrange the interactive elements 612 based on the last update date/time, such that projects which have been updated the most recently are at the end of the queue and projects that have been updated the least recently are at the beginning of the queue 610.

In other examples, the project update queue 610 includes an interactive element for each project for which an update is currently pending. In this example, projects for which updates have already been written in the current period are not included in the project update queue 610.

In the example writing mode user interface 600, queue 610 includes four interactive elements 612 corresponding to four of the projects 522A-522H in the projects section 520.

In some embodiments, each interactive element 612 in the queue 610 is selectable to navigate to (and display) the project update form in respect of the relevant project. In this way, the queue 610 may function as a navigation bar control element such that a user may conveniently identify and navigate to a desired project update form, skipping over intermediary project update forms, and may also select project update forms further along or behind the currently displayed project update form in the queue 610.

In UI 600, the first interactive element 612 corresponding to the first project is highlighted, indicating that the first project is currently selected in the queue. Thus, the project update form 620 for the first project is currently displayed.

The writing mode UI 600 includes an update form 620. The update form 620 may include a project name section 622 and information about the update due date 624. In addition, the project update form includes a project update data entry control 626, a project status control 628, a date/time indicator 630, and a post update control 632.

The project name section 622 displays the project field data relating to the project name of the project associated with interactive element 612. The client application 242 may use the project identifier of the project in question to identify a project details record in a project details table stored on the data store 230, retrieve the project field data relating to the project name, and display the project name in the project name section 622.

The project update data entry control 626 allows the user to input an update description (e.g. text) explaining the project update. The update description may be limited to a predefined maximum number of words or characters (e.g. 280 characters) to force the user to provide a succinct project update for their project.

If the user wishes to provide more words/characters beyond the word/character limit or more information relating to the project update, the project update form 620 may include a notes control (not shown). If the user selects the notes control, a notes data entry control may be displayed within the project update form 620 that allows the user to provide more information relating to the project (e.g., more characters/words beyond the limit and/or images).

The project status control 628 indicates the current project status of the project in question. The project status control 628 is prepopulated with the current status of the project. For example, the project update module 224 may determine the project identifier to which the project update form 620 relates, access the most recent project update record for the project in question in a project updates table stored in the data store 230, extract the project status from that project status update record, and display that project status in the project status control 628. The project update module 224 may determine the most recent project update record for a project based on the project identifier and timestamp of each project update record of the project updates table.

The user can update the project status of the project by selecting the project status control 628. Selection of the project status control 628 may cause the client application 242 of the user's user device 240 to display a list of predefined project statuses in the project update form 620 from which the user can choose (e.g., “Pending”, “On track”, “At risk”, “Off track”, “Paused”, “Cancelled”, “Completed”, or the like.).

The date/time indicator 630 indicates the time and/or date the project is estimated to be completed by. The date/time indicator 630 may be prepopulated with the current completion date of the project. For example, the project update module 224 may determine the project identifier to which the project update form 620 relates, access the most recent project update record for the project in question in a project updates table stored in the data store 230, extract the project completion date from that project update record, and display that completion date in the date/time control 630. The project update module 224 may determine the most recent project update record for a project based on the project identifier and timestamp of each project update record of the project updates table.

The user can update the completion date of the project by selecting the date/time control 630. Selection of the date/time control 630 may cause the client application 242 of the user's user device 240 to display a calendar in the project update form 620 from which the user can choose a particular date.

The post update control 632 allows a user to post (i.e. submit) the project data they have entered in the project update form 620. Selection of the post update control 632 causes the client application 242 to communicate the project update data to the project update module 224 which can then create a project update for the project in question (e.g. per operation 708 of the project update method 700 described below).

In addition to the project update form 620, the UI 600 also includes the previous project update 634 for that project. The previous project update object 634 includes information about the corresponding project, e.g. information of the corresponding project update record. In this example, the project update object 634 in respect of Project 1 is currently being displayed. In general, the project update object 634 displays information from the most recently submitted project update for the respective project. In some embodiments, the project update object 634 may be similar to the project update object 542 displayed in the UI 500. In other examples, the project update object 634 may including different, additional, or lesser information than the project update object 542. In one example, the project update object 634 may include a project update description section 644, an owner section 645. In addition, the project update object 634 may include a status indicator section 646, and a target date indicator section 647.

The project update description section 644 displays the details of the previous project update description relating to the respective project to which the displayed project update object 634 is directed. The project update description section 644 may also include additional notes and/or linked or embedded media or other content. If the user has previously provided any additional notes or content relating to the project, the project update object 634 may include a notes control that, when selected by the user, displays or expands the additional notes and/or content in relation to the previous project update (e.g. in a pop-up dialogue box or alternative UI element). The owner section 645 may display an avatar or picture and/or name of the user, e.g., the person viewing UI 600.

The status indicator section 646 displays previous project status. The target date indicator section 647 provides an indication of the previously determined date by which the project is due (or previously expected) to be completed. The target date indicator 647 may indicate a specific date, or a period of time (e.g. a specific month or a specific quarter). In case there is no target date (e.g., because the project has been deferred), the target date indicator 647 may display such status, e.g., “deferred.” In particular, the status indicator 646 and target date indicator 647 display the most recent project status and target date in respect of the project.

The user can view the previous project update 634 to help write the current update. For example, the user can check the project status and the project completion date from the last update to determine whether the project is still on track and/or whether the project status and/or completion date need to be updated. Further, from the text of the update, the user can re-familiarize themselves of the update that was previously announced so that the user does not inadvertently announce the same update and/or can build on that update. For example, if the previous update was, “stage 1 completed, looking forward to complete stage 2A next week.” The user can create a new update, such as, “Unfortunately we were unable to complete stage 2A due to a few roadblocks, will do so next week”, or “As expected, the team has crushed stage 2A of the project, we are moving on full steam ahead.”

The writing mode user interface 600 further includes previous and next navigation control elements 648 and 650, which are respectively configured to navigate along the project updates in the project update queue 610.

In the writing mode user interface 600, the project update form 620 and previous update 634 occupy substantially all of the display space of the interface 600 with a current project update form 620 and previous update 634 positioned centrally and desired control elements provided around these.

The writing mode user interface 600 omits extraneous UI elements, extraneous control elements, and extraneous information to provide a more streamlined interface for generating updates without any distractions. For example, the writing mode user interface 600 may strip away extraneous interface elements compared to a standard user interface, such as interface 500 (e.g., it does not include a control bar, a left side bar, a right side bar, or a task bar). Furthermore, writing mode user interface 600 may be displayed in the full screen (e.g., the UI 600 may fill the entire screen of the user device 240) such that every inch of the screen can be utilized and desktop distractions, such as notifications, other open browser tabs, etc. can be minimized).

While the writing mode user interface 600 is being displayed, the UI module 228 is configured to provide modified input functionality (for example by causing the client application 242 to respond to inputs particular to the writing mode user interface 600). In this example, the modified inputs are described as hotkeys, e.g., activations of keys of a keyboard 326 of the user device 240. In alternative embodiments, the modified inputs may be implemented by way of alternative input devices, for example, affordances and/or gestures on touch screen, dedicated input buttons of the device, or other suitable inputs. The writing mode user interface 600 may include a modified inputs guide section, in this example, a keyboard shortcuts guide section (not shown).

The keyboard shortcuts guide section may include a control element to expand the guide and display hotkeys and corresponding functionalities performed in response to activation of such hotkeys. Particular examples of modified input (hotkey) functionality for the writing mode user interface 600 may include detecting keyboard 326 inputs provided by a user at their user device 240 such as: detecting activation of a left arrow key and in response, navigating to a previous project update form; detecting activation of a right arrow key and in response, navigating to a next project update form; detecting activation of an “x” key and in response, starting over from the first project update form; detecting activation of an “m” key and in response, allowing a user to type an update in the input control 626; detecting activation of an “enter” key during a update entry in the input control 626 and in response, submitting the update for recording as an owner update against the project; detecting activation of a “d’ key and in response, displaying or activating an additional notes section; and detecting activation of an “Esc” key and in response, exiting the writing mode user interface. Many alternative inputs and many alternative responses are possible without departing from the scope of the present disclosure.

Advantageously, the writing mode user interface 600 disclosed herein may enable a user to view and write and/or update project updates they are responsible for in a single session in an efficient and easy to use interface. The writing mode user interface 600 is further configurable to allow full functionality responsive to modified inputs such that a user may view and engage with project update form controls utilising only the specially configured hotkeys, and thus, not necessarily requiring a cursor control device or the like. This may further improve the human-machine interface provided by the client application.

Returning to method 400, at 412, the UI module 228 is configured to provide modified input functionality, wherein inputs provided at the user device 240 affect alternative functions within the writing mode user interface 600 as compared to when the writing mode user interface 600 is not being displayed in the PC client application 242. For example, inputs (such as hotkeys in respect of a keyboard 326 or gestures or selections in respect of a cursor control device 324) input to the writing mode user interface 600 result in alternative functionalities as compared to the same inputs being input to another interface, such as the UI 500. Modified input functionality is described further below with respect to method 700.

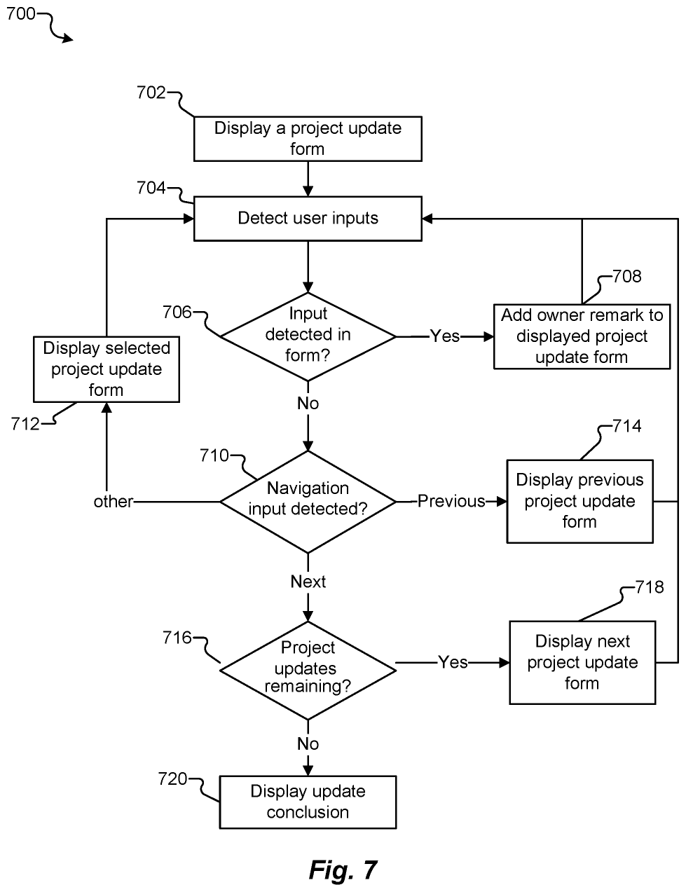

Referring to FIG. 7, the operations of displaying project update forms in a writing mode user interface 600 and providing modified input functionality will now be described. The operations of method 700 will be described as being performed by the (modules of) PC server application 220 running on the PC server system 210 and the PC client application 242 running on the user device 240. In alternative embodiments, the processing may be performed by one or more alternative systems (operating in conjunction with PC server system 210 and user device 240 or independently) and/or alternative applications running on those systems. Additionally, the method 700 will be described with reference to providing a single subscriber a subscriber update, although the method may be scaled to provide multiple subscribers the same or different respective subscriber updates.

Method 700 commences after step 410 of method 400—i.e., after the writing mode user interface 600 is displayed.

At step 702, the UI module 228 causes the PC client application 242 to display a project update form 620 and a previous project update 634 for that project in UI 600. Initially, the project update form 620 and project update 634 displayed will be for the first project in the queue 610.

At 704, while displaying a project update form 620 and previous project update 634 for a first project, the UI module 228 is configured to detect user inputs, for example, detected via an input/output device of the user device 240 such as a touch screen of display 318 or a keyboard 326. Inputs activated at the user device 240 may then be provided to the UI module 228, which is configured to cause the PC client application 242 to respond to the inputs with a modified functionality, particular to the writing mode user interface 600. Each user input may be relayed back to the UI module 228 of the PC server application 220, or alternatively, the UI module 228 may configure the client application 242 to locally respond to the detected user inputs based on the configured operations for the writing mode UI 600.

At 706, the client application 242 (and/or UI module 228) determines whether a user input has been detected in the project update form 620. A user input in the project update form may be, e.g., an input in control 628, control 630 or in input control 626. In this case, when an input is detected with respect to the project input form 620, the client application 242 and/or the server application 220 determines that the user wishes to generate an update with respect to the displayed project and the method proceeds to step 708, where the UI 600 allows the subscriber to perform the corresponding action.

For example, if an input is detected in input control 626, an editor bar may be activated and a cursor may be activated in the input control 626. The user can then directly type their update (e.g., using their keyboard). Once the user is satisfied with the update, the user can select another key, e.g., the “enter” key, which causes the comment entered in the input control 626 to be submitted or posted. Similarly, if an input is detected on the control 632, the comment entered in the input control 626 is submitted to the PC server application 220.

In particular, the client application 242 generates and communicates a request to update the project record to the project update module 224. The project update module 224 in turn receives the project update data from the user. It may be required that particular project update fields (i.e. the required project update fields) must be populated in order to create a project update. Accordingly, the project update module 224 may determine if the project update data received includes project update field data relating to the required project update fields. If so, the project update module 224 proceeds to store it. If not, the project update module 224 may alert a user to any missing data (e.g. by causing a prompt to be displayed on the UI 600) before processing returns to 706 to await for and receive further project update data.

The required project update fields may be system and/or user defined. For example, the PCT server 210 may define a set of required project update fields and an organization using the PCT may add further required project update fields. The project update data may also include data relating to one or more project update fields that do not need to be populated in order to create a project update (i.e. optional project update fields). By way of example, the PCT may require a status update to include an update description and a project status.

Once the required update data has been received, the project update module 224 creates a project update for the respective project based on the project update data received for that project at 708 and stores this project update against the project identifier for the project in the data store 230. For example, creating a project update may involve the project update module 224 creating a project update record in a project updates table stored in the data store 230 and populating the project update fields. The project update record defines the unique project identifier for the project to which the project update relates and one or more project update fields (e.g. the time the project update was created, the update description, and the project status). A given project update field of the project update is populated with project update field data from the project update data that relates to that project update field. Once the project update has been created and stored on the data store 230, the project update operation for that project can be considered completed.

While or once the project update has been updated, the client application 242 updates the writing mode user interface 600. For example, it may update the queue 610 to indicate that an update has been written and successfully posted for that project. In one example, this may be done by changing the state (e.g., color, design, shape, etc.) of the corresponding interactive element 612. In another example, the state of an icon associated with the interactive element 612 may be updated—e.g., a tick may be added, the color of the icon may be changed (e.g., it may be greyed-out, green, etc.).

In some examples, the position of the interactive element 612 may also change—e.g., it may be moved to the end of the queue. This way, projects that need to be updated may also be displayed towards the beginning of the queue 610 whereas completed updates may be moved to the end of the queue 610.

Further still, once the project update is posted, the writing mode user interface 600 may automatically cease display of the current project update and display the project update form 620 for the next project in the queue 610. If the current project was the last project in the queue, the writing mode user interface 600 may continue to display the current project update. Alternatively, it may display a completion page that shows a summary of the project updates written by the user.

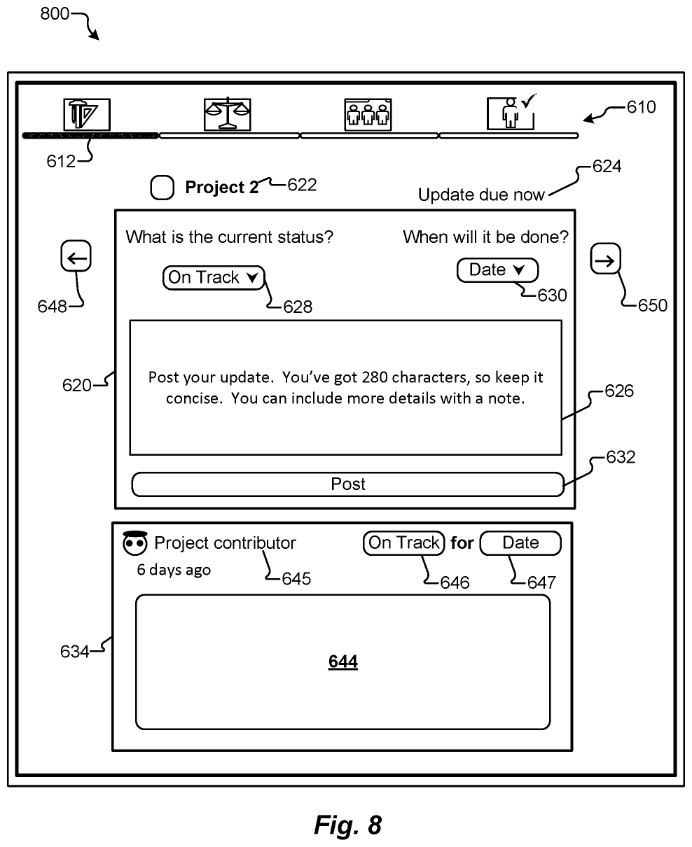

FIG. 8 shows the example writing mode user interface 800 after a project update for the first project is posted. In this state, the interactive element associated with the first project is moved to the end of the queue 610 and a tick mark is added to the icon associated with that project in the queue 610 to indicate that the project update has been completed for that project. The remaining projects are then pushed left along the queue 610 and the interactive element 612 for the second project in the queue is selected. Further still, a project update input form 620 for the second project is displayed in the main area of the UI along with the latest project update 634 for the second project.

Returning to step 706, if no (further) input(s) are detected in the project update form 620, the client application 242 is configured (e.g., by the UI module 228) to continue monitoring for user inputs.

At 710, the client application 242 (and/or UI module 228) determines whether a navigation input has been detected. For example, navigation inputs may include inputs to navigate to a next project update form, a previous project update form, or to another specific project in the queue 610 (e.g., to start over at the first project update). As an example, a left arrow key may be configured as a hotkey for displaying a previous project update; a right arrow key may be configured as a hotkey for displaying a next project update; and an “x” key may be configured as a hotkey for restarting and displaying the first project update. If activation of these hotkeys, activation of the controls 648, 650, or selection of a particular activation element in queue 610 is detected, the client application 242 is configured to navigate to the respective project update, e.g., by displaying the corresponding project update object 620.

In particular, if activation of a start over input is detected or if activation of a particular element in queue 610 is detected at 710, the method proceeds to step 712 where the client application 242 is configured to replace the currently displayed project update form with the project update form corresponding to the selected project, which is the first project in the queue 610 in case a start over input is detected or another project update form in case a random project activation element 612 is selected from the queue 610.

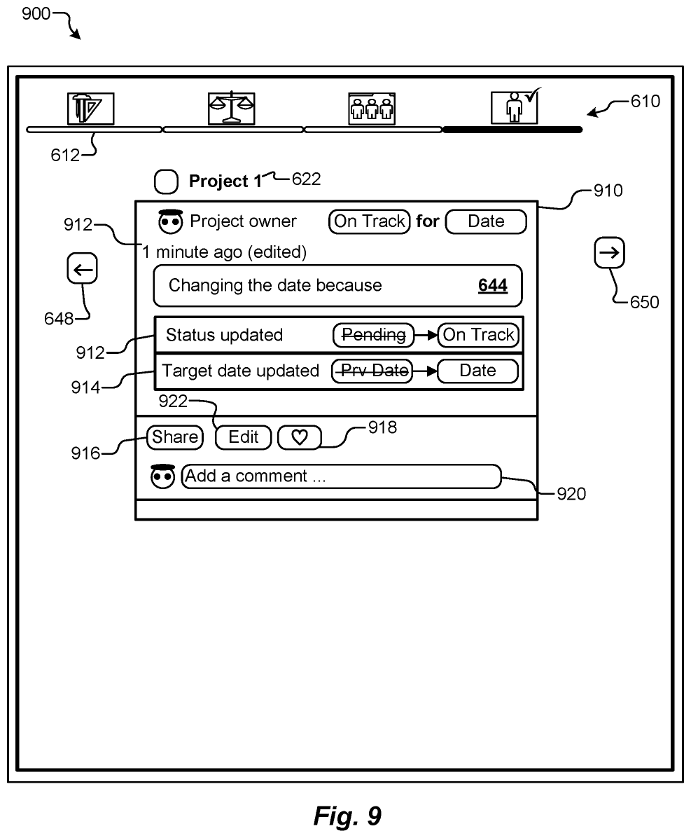

In case the randomly selected project activation element 612 corresponds to a project for which the user has already written an update, the newly created project update for that project is displayed in the main area of the UI 600. FIG. 9 shows an example of this state. In particular, it shows an example where the user selects the interactive element 612 corresponding to the first project (the last interactive element in the queue) at step 710. The user interface 900 shows the project update that was written by the user. To show this update, the client application 242 may send a request for the project update details to the server 210. The request includes an identifier of project 1. The server application 220 and in particular the user interface module 228 receives the request and performs a lookup with the project identifier in the project updates table and retrieves the latest project update for that project identifier. It communicates the project update data to the client application 242. The client application 242 receives the project update data and renders the project update 910 in the writing mode user interface 900. The project update 910 includes a date/time field 912 indicating the date/time the update was created (e.g., 1 minute ago). Further includes the project status 646, completion date 647, the update 644, an indication 912 of any change in the status of the project between this project update and the previous project update, and/or an indication 914 of any change in the completion date between this project update and the previous project update.

In addition, the project update 910 further includes control elements for the user to engage with the project update. User engagement control elements may include, e.g., a share control element 916, one or more reaction control elements 918, a comment control element 920, and an edit control 922. The share control element 916 allows a user to share the respective project update object 910, for example, with another user of the PC application and/or with (or via) an external application. The reaction control elements 918 allow the user to leave a remark, in the form of a reaction, on the respective project update. Reactions may be predefined defaults (e.g. smiley face, heart, thumbs up) or selected from a list of options (e.g. in a pop-up interface). Comment control element 920 allows the user to post a comment in relation to a project update object 910. If the subscriber selects the comment control 920, a comment interface may be displayed that allows the subscriber to enter and submit a comment. The remarks (e.g. reactions and comments) of project updates may be stored in a project update record relating to the project update in a project updates table stored on the data store 230.

The edit control 922 allows the user to edit the project update submitted. It will be appreciated that the user may be able to edit the project update while the user is within the writing mode user interface 600. Once the user exits the interface 600 they may no longer be able to edit the update. In other examples, the user may be able to edit the project update at any time within the current period. The edit control 922 may be displayed whenever the user is allowed to edit the project update. If the user is outside the permitted editing period, the edit control may not be displayed.

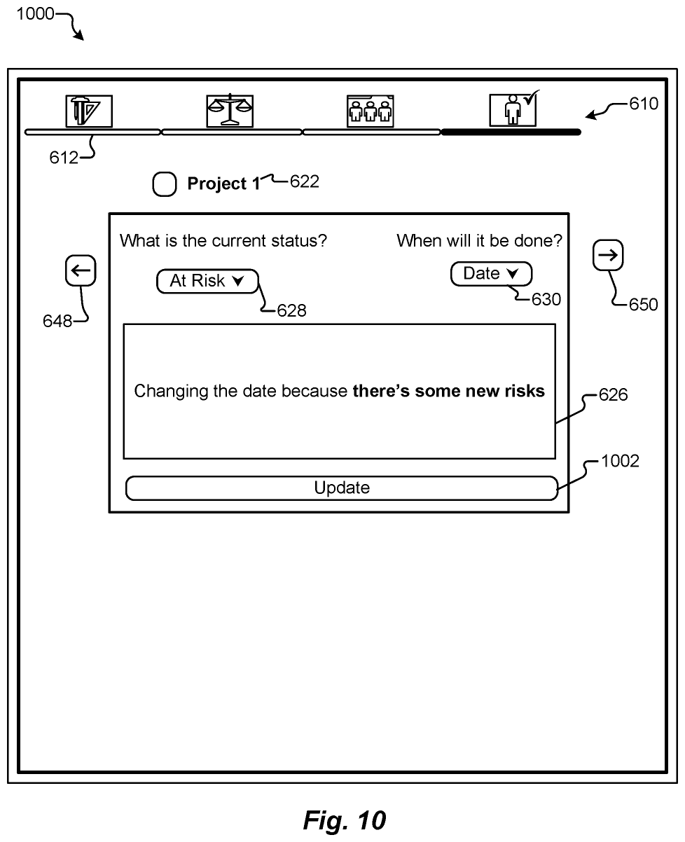

Once the user selects the editing control 922, the project update may be replaced by the corresponding project update input form 620. FIG. 10 displays an example of the writing mode user interface 1000 in this state. As shown, the writing mode user interface replaces the project update 910 with the project update input form 620. The project input form 620, however includes the previously entered values in control 628, 630, and 626. The user can change the values using of any of these controls. In this example, the user completes the project update in control 626 from “change the date because” to “changing the date because there's some new risks”.

The control to submit the update may also be different from that depicted in FIG. 6. Once the user selects the control 1002, the client application 242 performs the same method as it does when control 632 is selected and therefore it is not described here again. In this manner, the writing mode user interface 600 can be utilized not only for writing project updates but also to modify and edit these updates.

Returning to step 710 of method 700, if activation of the previous project is detected (e.g., left arrow or control 648) at step 710, the method proceeds to step 714, where the client application 242 is configured to replace the currently displayed project update form and previous update with the project update form and previous update for the previous project in the queue 610. If the currently displayed project update form is the first project update form (i.e. there is no previous projects) the client application 242 may be configured to continue displaying the first project update form and not perform any action.

If activation of the next project update input is detected (e.g., right arrow or control 650) at step 710, the method proceeds to step 716 where the client application 242 (and/or UI module 228) is configured to determine whether the user is currently viewing the last project in the queue 610 and/or whether there are any projects the user has not already provided an update for. If it is determined that further unviewed projects remain in the queue 610, the method proceeds to step 718 where the client application 242 is configured to replace the currently displayed project information with the project information corresponding to the next project in the queue 610.

Alternatively, if it is determined that no further projects remain in the queue 610, the method proceeds to step 720, where the client application 242 is configured to display an update conclusion. The update conclusion may replace the displayed final project information and may include a summary of the project updates the user has written in the session and/or a congratulation message for writing all the project updates. The client application 242 may be further configured to detect activation of a user input while displaying the subscriber update conclusion, for example, detection of start over input (e.g., activation of an “x” key hotkey) may cause the client application to start over by redisplaying the first project update object.

If at any time during process 700, activation of an exit input is detected (e.g., to exit the writing mode UI 600), the method 700 ends and the UI 600 is exited. In such cases, the user display may revert to the UI 500 upon exiting the writing mode.

The UIs and methods of operating the UIs are described with respect to projects. However, it will be appreciated that the UIs and methods of operation equally apply to other types of objects, such as goals in PCTs, social media posts or tweets in social media platforms, and/or tasks in project management applications without departing from the scope of the present disclosure.

In the above embodiments, certain operations are described as being performed by the user device 240 (e.g. under control of the client application 242) and other operations are described as being performed at the server system 210. Variations are, however, possible. For example in certain cases an operation described as being performed by user device 240 may be performed at the server system 210 and, similarly, an operation described as being performed at the server system 210 may be performed by the user device 240. Generally speaking, however, where user input is required such user input is initially received at user device 240 (by an input device thereof). Data representing that user input may be processed by one or more applications running on user device 240 or may be communicated to server system 210 for server application 220 running on the server system 210 to process. Similarly, data or information that is to be output to a user (e.g. via display, speaker, or other mechanism) will ultimately be generated by user device 240. The data/information that is output by the user device 240 may, however, be generated by client application 242 and/or the server application 220 (and communicated to the user device 240 to be output).

Furthermore, in certain implementations a computer processing system 300 may be configured (by an application running thereon) to perform the processing described herein entirely independently of a server system 210. In this case, the application running on that system is a stand-alone application and all instructions and data required to perform the operations described above a stored on user device 240.

In the embodiments described above and the figures, various examples of how different types of GUI elements (and/or different GUI areas/regions) may be visually distinguished are provided. Alternative means for visually distinguishing GUI elements are possible. By way of example, techniques for visually distinguishing GUI elements may include one or a combination of: shading colours; shading patterns; line colours; line weights; line styles; transparencies; icons; character annotations; and/or other visual techniques.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense. For example, a first UI could be termed a second UI or vice versa without departing from the scope of the described examples. Furthermore, when used to differentiate elements or features, a second UI could exist without a first UI. For example, a second user input could occur before a first user input (or without a first user input ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute should be considered as a required or essential feature. Accordingly, the specification and drawings are to be regarded in an illustrative rather than a restrictive sense.

1. A computer implemented method comprising:
maintaining a plurality of object updates in a data store, each object update associated with an object and including a latest object information associated with the object;
displaying a standard user interface, the standard user interface including display of the plurality of object updates associated with a user;
detecting activation of a writing mode control;
in response to detecting activation of the writing mode control, replacing the standard user interface with a writing mode user interface, the writing mode user interface including display of a first object update form of a plurality of object update forms; and
while displaying the writing mode user interface, detecting a navigation input and in response to the navigation input, ceasing display of the first object update form and displaying a second object update form of the plurality of object update forms in the writing mode user interface.

2. The computer implemented method of claim 1, wherein the second object update form is associated with a second object, and the writing mode user interface displays a previous object update associated with the second object while displaying the second object update form.

3. The computer implemented method of claim 1, further comprising providing modified input functionality when displaying the writing mode user interface, wherein the same input at an input device results in an alternative operation being performed in the writing mode user interface as compared to the standard user interface.

4. The computer implemented method of claim 1, wherein the writing mode user interface includes:
an object update queue, the object update queue indicating a number of object updates associated with a user viewing the writing mode user interface; or
an object update queue, the object update queue indicating a number of object updates associated with a user viewing the writing mode user interface that are to be completed in a current period.

5. The computer implemented method of claim 4, wherein the object update queue including a plurality of interactive elements, each interactive element corresponding to an object update associated with the user viewing the writing mode user interface, the plurality of interactive elements displayed sequentially.

6. The computer implemented method of claim 5, further comprising:
detecting an input in the object update queue, the input selecting an interactive element of the plurality of interactive elements that corresponds to a third object update,
changing a display state of the selected interactive element, to indicate that the interactive element has been selected; and
ceasing display of the second object update form and displaying a third object update form in the writing mode user interface.

7. The computer implemented method of claim 5, wherein while displaying the second object update form in the writing mode user interface further comprises:
detecting a user input;
determining whether the user input is to write an update in the second object update form; and
upon determining that the user input is to write the update, generating a second object update based on the user input and storing the object update in an object updates database.

8. The computer implemented method of claim 7, further comprising moving the interactive element associated with a second object to an end of the object update queue.

9. The computer implemented method of claim 7, further comprising:
detecting selection of the interactive element associated with a second object after the second object update is generated, and
updating the writing mode user interface to display the generated second object update, the second object update including an edit control to edit the generated second object update.

10. The computer implemented method of claim 9, further comprising:
detecting selection of the edit control;
ceasing to display the generated second object update, and
displaying the second object update form.

11. The computer implemented method of claim 1, while displaying the writing mode user interface, further comprising:
detecting activation of an exit input;
ceasing to display the writing mode user interface; and
displaying the standard user interface.

12. A computer processing system comprising:
a processing unit;
a display;
an input device; and
a non-transitory computer-readable storage medium storing instructions, which when executed by the processing unit, cause the processing unit to:
maintain a plurality of object updates in a data store, each object update associated with an object and including a latest object information associated with the object;
display a standard user interface, the standard user interface including display of the plurality of object updates associated with a user;
detecting activation of a writing mode control;
in response to detecting activation of the writing mode control, replacing the standard user interface with a writing mode user interface, the writing mode user interface including display of a first object update form of a plurality of object update forms, each object update form associated with a respective object; and
while displaying the writing mode user interface, detecting a navigation input and in response to the navigation input, ceasing display of the first object update form and displaying a second object update form of the plurality of object update forms in the writing mode user interface.

13. The computer processing system of claim 12, wherein the second object update form is associated with a second object, and the writing mode user interface displays a previous object update associated with the second object while displaying the second object update form.

14. The computer processing system of claim 12, further comprising providing modified input functionality when displaying the writing mode user interface, wherein the same input at the input device results in an alternative operation being performed in the writing mode user interface as compared to the standard user interface.

15. The computer processing system of claim 12, wherein the writing mode user interface includes:
an object update queue, the object update queue including a plurality of interactive elements, each interactive element corresponding to an object associated with a user viewing the writing mode user interface; or
an object update queue, the object update queue including a plurality of interactive elements, each interactive element corresponding to an object associated with a user viewing the writing mode user interface for which an update is due in a current period.

16. The computer processing system of claim 15, wherein the plurality of interactive elements are displayed sequentially.

17. The computer processing system of claim 15, wherein the non-transitory computer-readable storage medium storing further instructions, which when executed by the processing unit, cause the processing unit to:
while displaying the second object update form in the writing mode user interface:
detect a user input;
determine whether the user input is to write an update in the second object update form; and
upon determining that the user input is to write the update, generate a second object update based on the user input and storing the object update in an object updates database.

18. The computer processing system of claim 17, wherein the non-transitory computer-readable storage medium storing further instructions, which when executed by the processing unit, cause the processing unit to move the interactive element associated with a second object to an end of the object update queue.

19. The computer processing system of claim 17, wherein the non-transitory computer-readable storage medium storing further instructions, which when executed by the processing unit, cause the processing unit to:
detect selection of the interactive element associated with a second object after the second object update is generated, and
update the writing mode user interface to display the generated second object update, the second object update including an edit control to edit the generated second object update.

20. The computer processing system of claim 19, wherein the non-transitory computer-readable storage medium storing further instructions, which when executed by the processing unit, cause the processing unit to:
detect selection of the edit control;
cease to display the generated second object update, and
display the second object update form.
